(19) United States
(12) Patent Application Publication
(10) Pub. No.: US 2025/0080038 A1
(43) Pub. Date: Mar. 6, 2025

(54) SOLAR MOUNT

(71) Applicant: Monument Solar, LLC, Orem, UT (US)

(72) Inventors: Kenson Pribyl, Orem, UT (US); Jana Pribyl, Orem, UT (US)

(73) Assignee: Monument Solar, LLC, Orem, UT (US)

(21) Appl. No.: 18/822,196

(22) Filed: Aug. 31, 2024

Related U.S. Application Data
(60) Provisional application No. 63/580,353, filed on Sep. 1, 2023.

(51) Int. Cl. H02S 20/30; B60R 16/03

(52) U.S. Cl. CPC H02S 20/30; B60R 16/03

(57) ABSTRACT

A solar mount may allow for solar panels to be mounted thereon and positioned at various different angles. The solar mount may include one or more ladder racks that mount to a surface such as the roof of a vehicle. Cables may be tensioned and provide support between the one or more ladder racks. Pivoting brackets may allow solar panels to be secured to the ladder racks. The pivoting brackets may allow the solar panels to be angled in one direction such that part of the solar panel forms a negative angle with the ladder racks and part of the solar panel forms a positive angle with the ladder racks. The pivoting brackets may allow the solar panels to be angled in an opposite direction such that the solar panel forms a positive angle with the ladder rack.

### RELATED APPLICATIONS

This application claims priority to U.S. Provisional Application Ser. No. 63/580,353, filed on Sep. 1, 2023.

### BACKGROUND OF THE INVENTION

Solar panels are well known in the art and have been around for over one hundred years. Over the years since solar panels were introduced, solar panels have become more efficient at producing renewable energy and have also become more available to the public. As a consequence of this, solar panels are becoming increasingly popular to provide needed energy. Today, solar panels are becoming more commonly used in connection with residential homes, campers, recreational vehicles, portable generators, etc. It is particularly beneficial to be able to use solar panels in association with recreational vehicles to provide needed power to the various systems of the RV, appliances, lights, electronic devices, etc.

Accordingly, there has been an ongoing need for improvements in securely mounting solar panels to recreational vehicles to allow more people to use and enjoy the benefits of solar panels in association with their recreational vehicles. Therefore, new apparatuses, methods, and systems related to mounting solar panels to recreational vehicles would be well received by members of the public.

### SUMMARY OF THE INVENTION

A solar mount may be comprised of two or more ladder racks wherein each ladder rack is comprised of two feet, two vertical bars, and one crossbar, wherein the feet of the ladder racks are configured to be secured to a surface. The surface to which they secure may be the roof of a vehicle, such as a recreational vehicle.

One or more cables configured to connect to and provide support to the two or more ladder racks. The cables may connect to the feet and vertical bars of the ladder racks. One or more tensioning nuts may be in line with the one or cables such that the one or more cables may be tensioned or loosened by the tensioning nuts.

One or more pivoting brackets comprised of one or more saddle mounts, a front lower swing arm, a rear lower swing arm, a front upper swing arm, a rear upper swing arm, a support bar, and one or more struts, wherein the front lower swing arm may be secured to a ladder rack by one or more saddle mounts, wherein the rear lower swing arm may be secured to an adjacent ladder rack by one or more saddle mounts, wherein the front upper swing arm may be secured to the front lower swing arm at a first front locking pivot point and a second front locking pivot point and the rear upper swing arm may be secured to the rear lower swing arm at a first rear locking pivot point and at a second rear locking pivot point, wherein a solar panel may be secured to the front and rear upper swing arms, wherein the support bar may be positioned to extend from the front upper swing arm to the rear upper swing arm and configured to provide support to the solar panel.

The solar panel may pivot at the second pivot points and be secured into a desired position by the one or more struts such that a portion of the solar panel forms a negative angle in relation to the crossbars of the ladder racks and a portion of the solar panel forms a positive angle in relation to the crossbars of the ladder racks, or the solar panel may pivot at the first pivot points and be secured into a desired position by the one or more struts such that the solar panel forms a positive angle with the crossbars of the ladder racks.

The solar mount may contain two pivoting brackets that may beach secure a solar panel on the same two ladder racks such that an alley way is formed between the two solar panels.

### BRIEF DESCRIPTION OF THE DRAWINGS

Various embodiments, methods, and systems will be described herein and explained with additional specificity and detail through the use of the accompanying drawings, in which:

FIG. 1 illustrates a top perspective view of the solar mount;

FIG. 2 illustrates a front perspective view of the solar mount of FIG. 1.

FIG. 3 illustrates a bottom plan view of the solar mount of FIGS. 1 and 2;

FIG. 4 illustrates a side elevational view of the solar mount of FIGS. 1-3;

FIG. 5 illustrates a top perspective view of a foot of the solar mount of FIGS. 1-4;

FIG. 6 illustrates a bottom plan view of the foot of FIG. 5;

FIG. 7 illustrates a rear elevational view of the foot of FIGS. 5 and 6;

FIG. 8 illustrates a right side elevational view of the foot of FIGS. 5-7;

FIG. 9 illustrates a top perspective view of a saddle mount of a pivoting bracket assembly of the solar mount of FIGS. 1-4;

FIG. 10 illustrates a top perspective view of a rear lower swing arm of the pivoting bracket assembly of the solar mount of FIGS. 1-4;

FIG. 11 illustrates a top perspective view of a front lower swing arm of the pivoting bracket assembly of the solar mount of FIGS. 1-4;

FIG. 12 illustrates a top perspective view of a front upper swing arm of the pivoting bracket assembly of the solar mount of FIGS. 1-4;

FIG. 13 illustrates a top perspective view of a rear upper swing arm of the pivoting bracket assembly of the solar mount of FIGS. 1-4;

FIG. 14 illustrates a top perspective view of a solar panel support bar of the pivoting bracket assembly of the solar mount of FIGS. 1-4;

FIG. 15 illustrates a front elevational view of the solar panel support bar of FIG. 10;

FIG. 16 illustrates a partial perspective view of the solar mount of FIGS. 1-4 attached to the roof of a vehicle with the solar panels at a ninety-degree angle.

FIG. 17 illustrates a zoomed-up perspective view of the solar mount of FIGS. 1-4 showing a strut of the solar mount; and

FIG. 18 illustrates a top perspective view of the solar mount of FIGS. 1-4 showing various positions options for mounted solar panels.

### DETAILED DESCRIPTION OF THE PREFERRED EMBODIMENTS

As shown in the drawings and for purposes of illustration, the one or more embodiments disclose a solar mount for mounting solar panels to the roof of a vehicle which may be a recreational vehicle. One skilled in the art would recognize that although the solar mount may be applied to a recreational vehicle, it may also be applied to any vehicle, any structure, such as a home, building, shed, etc., or even to the ground. The solar mount will be referred to herein by the reference numeral 10.

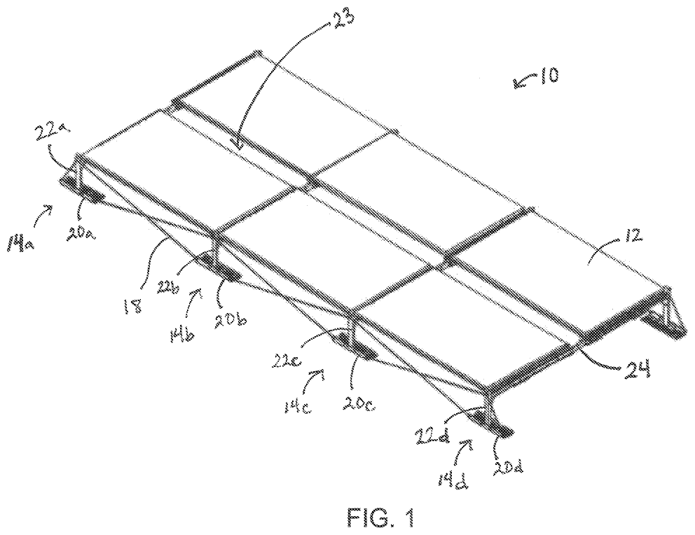

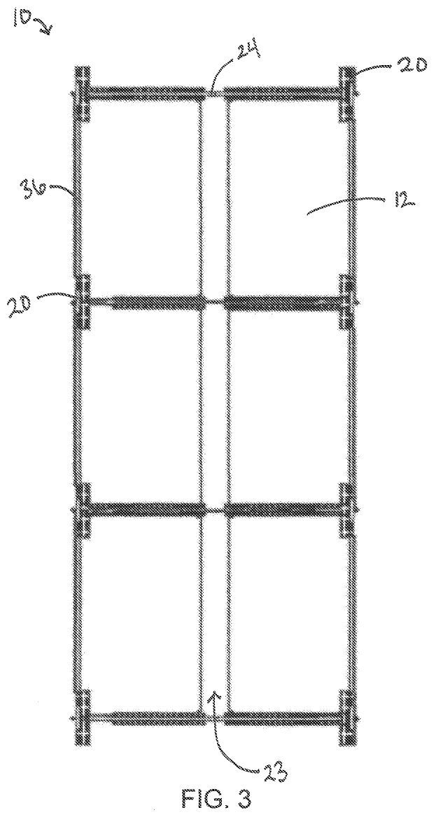

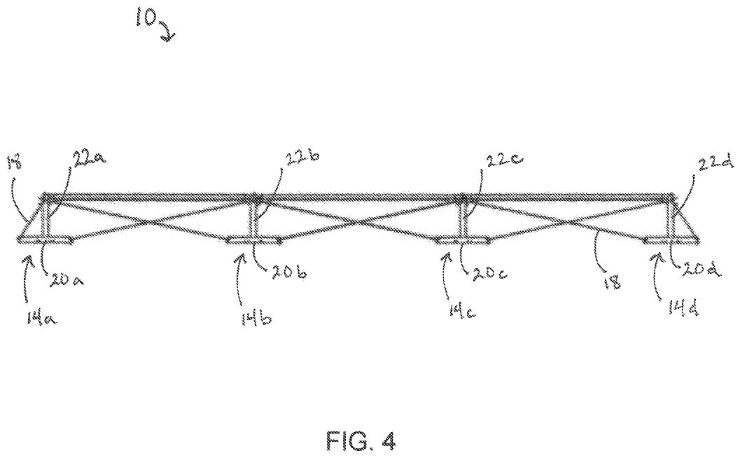

With reference now to FIGS. 1-4 various views of the solar mount 10 with mounted solar panels 12 are illustrated. Generally, the solar mount 10 may include ladder racks 14, pivoting brackets 16, and support cable 18. The ladder racks 14 may be secured to the roof of a vehicle, the pivoting brackets 16 may be secured to the ladder racks 14, the support cable 18 may provide additional support to the ladder racks 14 and system as a whole, and the solar panels 12 may be secured to the pivoting brackets 16. In this manner, solar panels 12 may be mounted to the roof of a vehicle.

As described above, the solar mount 10 may include ladder racks 14. More specifically, the solar mount 10 may include one or more ladder racks 14. Some embodiments may include two ladder racks 14, some three, some four, etc. Generally, fewer ladder racks 14 would be provided for vehicles with shorter lengths and more ladder racks 14 would be provided for vehicles with longer lengths.

The ladder racks 14 may include feet 20, vertical bars 22, and crossbars 24. Generally, the feet 20 may be mounted on the roof of a vehicle, the vertical bars 22 may extend upwards from the feet 20, and the crossbars 24 may extend across the roof of the vehicle connecting the vertical bars 22. In some embodiments, for each ladder rack 14, two feet 20 may be mounted on the roof of a vehicle with one on each side of the roof so as to be in horizontal alignment with each other in relation to the roof. The feet 20 may be mounted through the use of glue and bolts such that the feet 20 are secured to the roof of the vehicle by glue and then further secured to the roof of the vehicle by being bolted to the roof. The feet 20 may also be mounted to the roof of the vehicle by any other method known in the art. At least one vertical bar 22 may be secured to each foot 20 and may extend vertically therefrom. The feet 20 of the ladder rack 14 may be adjusted to be in line with the slope of the roof of the vehicle. Because of this, on some vehicles and in some positions on a roof, the vertical bars 22 may extend upward perpendicularly to the feet 20 of the ladder rack 14 or may extend upward at some other angle in relation to the feet 20 of the ladder rack 14. As already mentioned above, the crossbars 24 may be secured to each vertical bar 22 and extend horizontally across the roof of the vehicle.

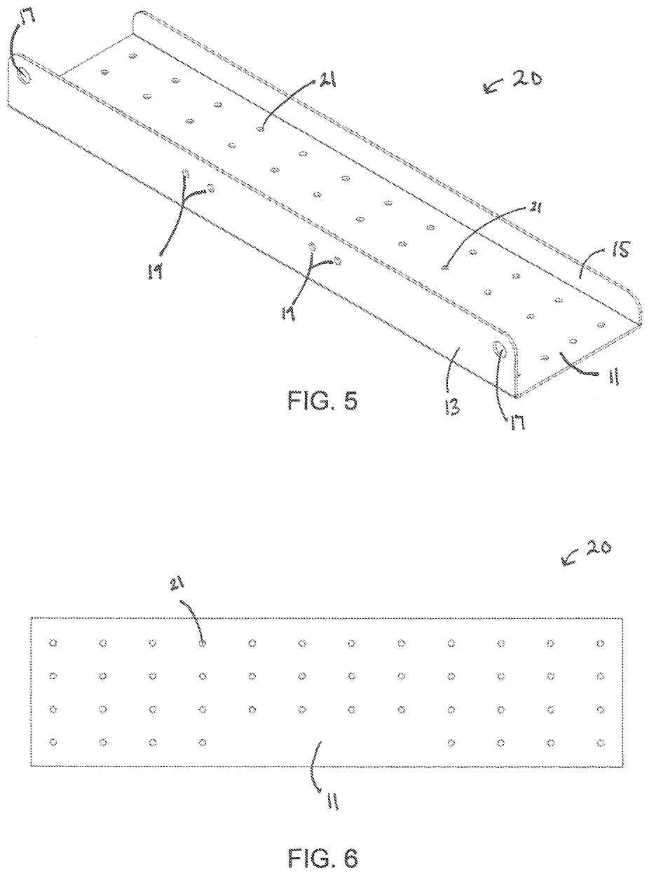

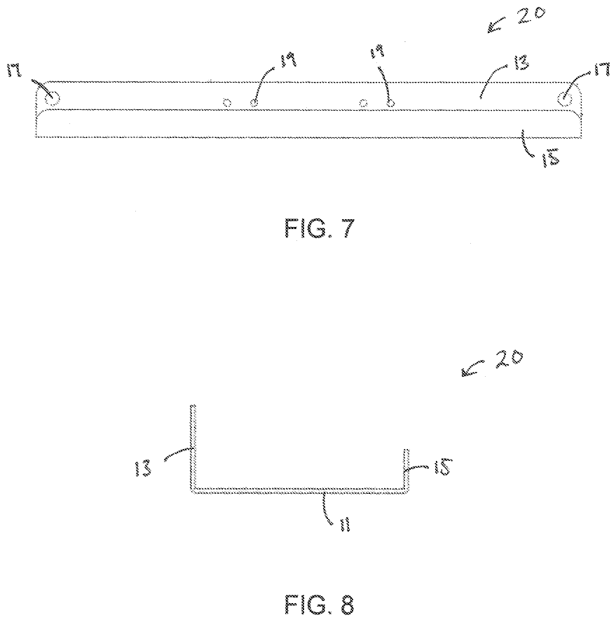

As best seen in FIGS. 5-8, the feet 20 may each include a base plate 11, a front perpendicular plate 13, and a rear perpendicular plate 15. The base plate 11 may be secured to the roof of a vehicle as described above and the front and rear perpendicular plates 13 and 15 may extend upward, each from one of the edges of the base plate 11 so as to form a ninety-degree angle with the base plate 11. The front perpendicular plate 13 may extend upward from a front edge of the base plate 11 facing outward and the rear perpendicular plate 15 may extend upward from a rear edge of the base plate 11 facing inward. The base plate 11 may include a plurality of apertures 21 through which the base plate 11 may be secured to the roof of a vehicle by nut and bolt. The front perpendicular plate 13 may include one or more cable apertures 17 through which the cable support 18 may be secured and tensioned. In some embodiments the front perpendicular plate 13 may include two cable apertures 17 with one proximate to a front edge of the front perpendicular plate 13 facing the front of the vehicle and with one proximate to a rear edge of the front perpendicular plate 13 facing the rear of the vehicle. The front perpendicular plate 13 may further include one or more bar mounting apertures 19. The bar mounting apertures 19 may be located proximate to the center of the front perpendicular plate 13. In some embodiments, the front perpendicular plate 13 may include four bar mounting apertures 19 with two to the right of and proximate to the center of the front perpendicular plate 13 and two to the left of and proximate to the center of the front perpendicular plate 13. The bar mounting apertures 19 may function to secure the vertical bars 22 to the feet 20. In some embodiments, the vertical bars 22 may be secured to the feet 20 through nut and bolt.

With reference now back to FIGS. 1-4, the vertical bars 22 may be secured to one or both of the base plate 11 and the front perpendicular plate 13 of the feet 20. In some embodiments, the vertical bars 22 may include apertures through which the cable support 18 may be threaded and/or secured such as through an eyebolts attached to the vertical bars 22. In some embodiments, the apertures may be located near the top of the vertical bars 22. The vertical bars 22 may all be the same length or may vary in length such that the crossbars 24 of the ladder racks 14 are in parallel with each other and within the same plane. The vertical bars 22 may also vary in length to provide greater or lesser space between the crossbars 24 and the roof of the vehicle. Some embodiments may provide for more space to clear other items on the roof of a vehicle such as exhaust fans. Other embodiments may provide for less space between the crossbars 24 and the roof.

The cable supports 18 may provide support between two or more ladder racks 14 by being threaded and tensioned through the apertures of the feet 20 and the vertical bars 22. For example, the cable support 18, may zigzag from one foot 20 of a ladder rack 14 to a vertical bar 22 secured to that foot 20, to a foot 20 on a second ladder rack 14, to a vertical bar 22 of a third ladder rack 14, etc. In one embodiment, with four ladder racks 14, the cable support 18 may start at a foot 20 of a first ladder rack 14, go forward through a vertical bar 22 of the first ladder rack 14, go forward through a foot 20 of a second ladder rack 14, go forward through a vertical bar 22 of a third ladder rack 14, go forward through a foot 20 of a fourth ladder rack 14, go back through a vertical bar 22 of the fourth ladder rack 14, go back through a foot 20 of the third ladder rack 14, go through a vertical bar 22 of the second ladder rack 14, and connect back to the foot 20 of the first ladder rack 14. The cable support 18 may be tensioned through a tensioning nut or through any other means known in the art. Separate cable supports 18 may be on both sides of the two or more ladder racks 14. In some embodiments, more than one cable support 18 may be used on a single side of the one or more ladder racks 14.

In one embodiment, the solar mount 10 may be comprised of a plurality of cable support 18. One cable support 18, for example, may secure to a first vertical bar 14a by a clip and extend down to the a second foot 20b and attach to a cable aperture 17 of the second foot 20b by another clip. A cable tensioner may be implemented between a clip and the cable 18 to allow the cable 18 to be tensioned. Another cable support 18 may be secured and tensioned in similar manner between a second vertical bar 14b and a first foot 20a. Similarly, support cables 18 may be secured and tensioned between the second vertical bar 14b and a third foot 20c, between a third vertical bar 14c and a second foot 20b, between a fourth vertical bar 14d and a third foot 20c, between a third vertical bar 14c and a fourth vertical foot 20d, etc. The front feet 20, closest to the front of the vehicle may each have a cable 18 attached and tensioned to the front feet 20 and to the front vertical bars 14 in similar manner to that described above. The back feet 20 and back vertical bars 14 may also each have cable 18 attached in similar manner.

As described above, the crossbars 24 may extend horizontally across the roof of a vehicle and connect two vertical bars 22 together. In some embodiments, the crossbars 24 of the two or more ladder racks 14 may all be parallel with each other and may be positioned within the same plane as each other. In some embodiments, the crossbars 24 may be one with the vertical bars 22. In other embodiments, the crossbars 24 may be removably secured to the vertical bars 22. In some embodiments, the crossbar 24 may be one solid bar. In other embodiments, the crossbar 24 may be in two or more segments and may be adjustable in length.

The solar mount 10 may also be comprised of an open alley 23 going vertically from the front of the vehicle to the back of the vehicle down the middle of the solar mount 10. The open alley 23 may go vertically down the middle of the solar mount 10 such that the solar panels 12 are split into two columns with a single row of solar panels 12 on each side of the open alley 23 as shown in the figures. The open alley 23 may allow a user to get onto the roof of the vehicle and to walk along the open alley without having to remove or adjust the angle of the solar panels 12.

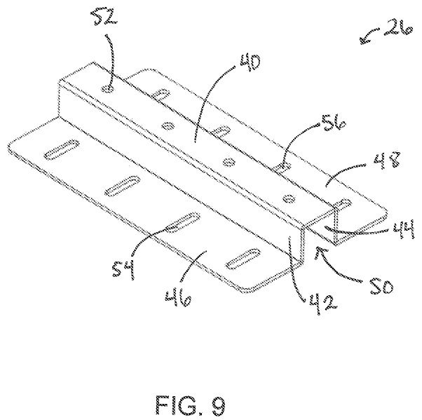

With reference now to FIGS. 9-18, various components of the pivoting brackets 16 are illustrated. The solar mount 10 may include one or more pivoting brackets 16. In general, the solar mount 10 may include one pivoting bracket 16 for each solar panel 12 to be mounted to the roof of a vehicle. In some embodiments, a set of two ladder racks 14 may each have two pivoting brackets 16 such that two solar panels 12 may be secured to any set of two ladder racks 14. For example, in a system with four ladder racks 14a-b, the first and second ladder racks 14a and 14b may be a set and may include two pivoting brackets 16, the second and third ladder racks 14b and 14c may be a set and may include two pivoting brackets 16, and the third and fourth ladder racks 14c and 14d may be a set and may include two pivoting brackets 16. In this example, the solar mount system 10 would include six pivoting brackets 16 and six solar panels 12.

Each pivoting bracket 16 may include one or more saddle mounts 26, a front lower swing arm 28, a rear lower swing arm 30, a front upper swing arm 32, a rear upper swing arm 34, a support bar 36, and one or more struts 38. Generally, the one or more saddle mounts 26 may act to secure the pivoting bracket 16 to the ladder racks 14. The front and rear lower swing arms 28 and 30 may act as a base of the pivoting bracket 16 being secured to the one or more saddle mounts 26 and to provide pivot points to the front and rear upper swing arms 32 and 34. The front and rear upper swing arms 32 and 34 may act to secure a solar panel 12 to the pivoting bracket 16 and may also attach to the front and rear lower swing arms 28 and 30 in a manner that they may pivot. The support bar 36 may act to provide support to the solar panel 12 to prevent the solar panel 12 from flexing when attached to the pivoting bracket 16. In general, the pivoting bracket 16 may allow the solar panel 12 to lie flat on the solar mount 10 or to be positioned at one or more different angles in relation to the roof of a vehicle. The one or more struts 38 may be used to secure the solar panels 12 in their desired angles.

With reference now specifically to FIG. 9, a perspective view of the saddle mount 26 is illustrated. The saddle mount 26 may be made up of a securing face 40, a front side wall 42, a rear side wall 44, a front wing 46, a rear wing 48, and a channel, 50. The securing face 40 may be a flat metal rectangular bar and the front and rear side walls 42 and 44 may extend downward from the securing face 40 at a ninety degree angles one from each length of the securing face 40. In this manner, the securing face 40 and the front and rear side walls 42 and 44 may form a hollow square u-bar that defines a channel 50. The front and rear wings 46 and 48 may extend at a ninety-degree angle from the bottom lengths of side walls 42 and 40 with the front wing 46 facing forward, or towards the front of the vehicle on which the solar mount 10 is mounted and with the rear wing 48 facing the rear, or towards the rear of the vehicle on which the solar mount 10 is mounted. The securing face 40 may have one or more apertures 52 which may be used to secure the saddle mount 26 to a crossbar 24 of a ladder rack 14 through the use of bolts, nuts, and washers. The front and rear wings 46 and 48 may have elongated apertures 54 and 56. The elongated apertures 54 of the front wing 46 may be used to secure the rear lower swing arm 30 of the pivot bracket 16. The elongated apertures 56 of the rear wing 48 may be used to secure the front lower swing arm 28 of the pivot bracket 16.

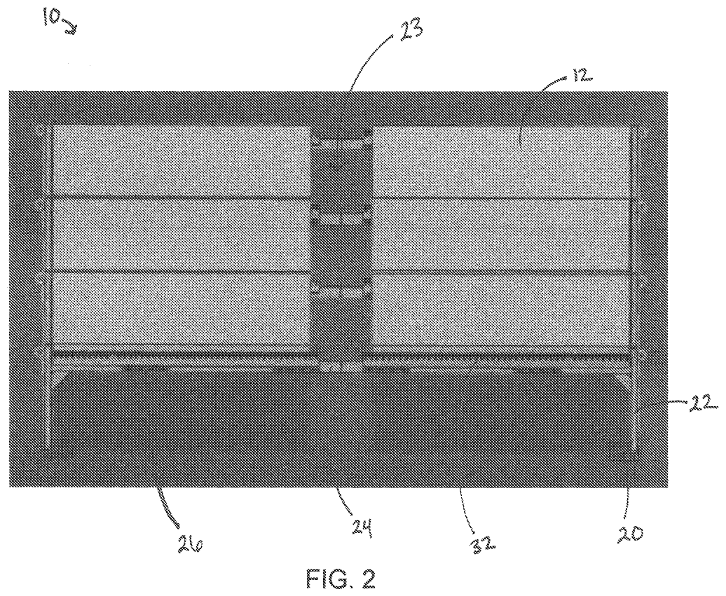

For example, as best seen in FIGS. 2, 16, and 17, the saddle mount 26 may be placed over a crossbar 24 of a ladder rack 14 such that the crossbar 24 is within the channel 50 of the saddle mount 26 with the securing face 40 resting on top of the crossbar 24 and the side walls 42 and 44 resting at the sides of the crossbar 24. Bolt, nuts, and washers may be used to secure the saddle mount 26 to the crossbar 24 through using the apertures 52 of the securing face 40. In this manner, the front wing 46 will face forward toward the front of the vehicle and the rear wing 48 will face backward toward the rear of the vehicle. In one embodiment, four saddle mounts 26 may be placed on each ladder rack 14, but one skilled in the art would recognize that the number of saddle mounts 26 per ladder rack 14 may vary with different embodiments.

In some embodiments, the solar mount 10 may include front and rear caps. The front cap may attach to the front of the solar mount 10 and the rear cap may attach to the rear of the solar mount 10. The front and rear caps may be aerodynamic in shape and function to move air over and around the solar mount 10 while a vehicle to which the solar mount 10 is attached is in motion. As best seen in FIG. 2, the front wings 46 of the saddle mounts 26 attached to frontmost ladder rack 14 may extend forward from the ladder rack 14. The front cap may utilize these front wings 46 when being secured to the solar mount. Similarly, the rear cap may utilize the rear wings 48 of the saddle mounts 26 attached to the rearmost ladder rack 14. The front and rear caps may have a height and a length close to and/or matching the height and length of the front and rear ladder racks 14 respectively. The front and rear caps may also have a depth and shape to provide an aesthetic and completed look to the solar mount 10 and to provide for increased aerodynamics as discussed above.

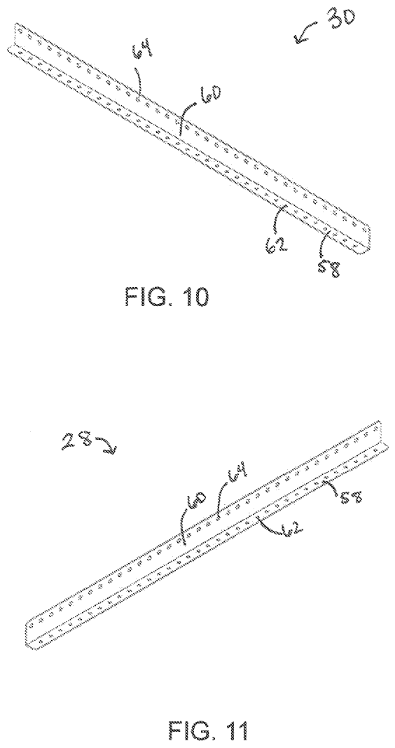

With reference now specifically to FIGS. 10 and 11, the front and rear lower swing arms 28 and 30 are illustrated. The front and rear lower swing arms 28 and 30 may provide a base framework of the pivoting brackets 16. The front and rear lower swing arms 28 and 30 may be L-bars each having a mounting face 58 and a pivot face 60 connected to form a ninety-degree angle along lengths of the mounting face 58 and the pivot face 60. The mounting face 58 may have a width that is smaller than the width of the pivot face 60. The mounting face 58 may have a plurality of apertures 62 running along the length of the mounting face 58. The pivot face 60 may also have a plurality of apertures 64 running along the length of the pivot face 60. Sets of the apertures 62 may be designed to line up with the elongated apertures 56 of the saddle mount 26 such that each aperture 64 may be aligned with an elongated aperture 56 of the saddle mount 26 according to the user's desire. Once a set of apertures 62 is lined up with the elongated apertures 56 of the saddle mount 26 according to the user's desire, the upper and lower swing arms 28 and 30 may be secured to saddle mounts 26 through the use of bolts, nuts, and washers. In this manner, the positioning of the upper and lower swing arms 28 and 30 may be adjusted according to the user's desire and roof size. In some embodiments, the front and rear lower swing arms 28 and 30 may be connected to two saddle mounts 26 each. However, more saddle mounts 26 may be used if desired.

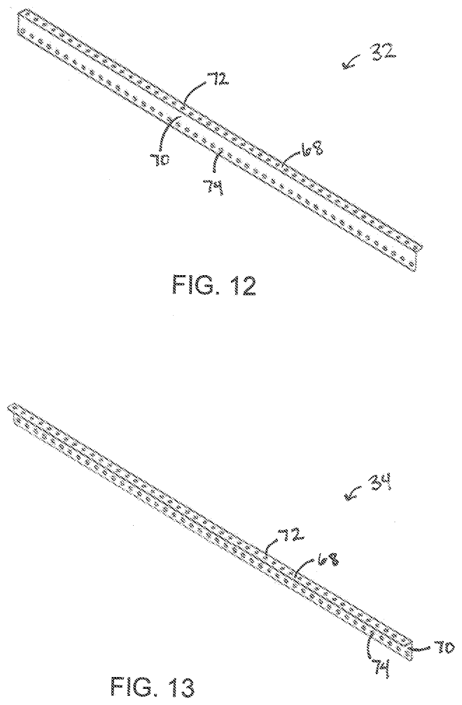

With reference now specifically to FIGS. 12 and 13, the front and rear upper swing arms 32 and 34 are illustrated. The front and rear upper swing arms 32 and 34 may also be L-bars each having a solar face 68 and a pivot face 70 connected to form a ninety-degree angle along lengths of the solar face 68 and the pivot face 70. The solar face 68 may have a width that is smaller than the width of the pivot face 70. The solar face 68 may have a plurality of apertures 72 running along the length of the solar face 68. The pivot face 70 may also have a plurality of apertures 74 running along the length of the pivot face 70.

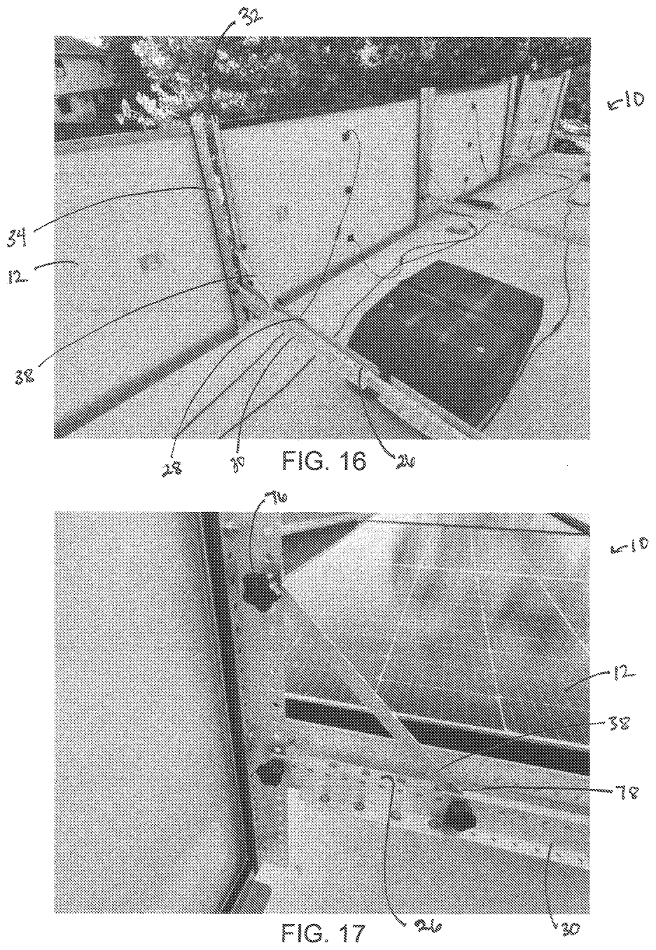

The solar face 68 may be configured to mount to a frame of a solar panel 12 as best seen in FIGS. 16 and 17. In some embodiments, the solar face 68 may mount to the width of a frame of the solar panel 12. The solar face 68 may mount to the solar panel 12 through the use of bolts, nuts, and washers using the apertures 72 of the solar face 68. In this manner, a solar panel 12 may be secured to the upper front and rear swing arms 32 and 34.

The pivot faces 70 of the upper front and rear swing arms 32 and 34 may pivotally connect with and be secured to the pivot faces 60 of the lower front and rear swing arms 28 and 30 respectively. This may be accomplished through the use of the apertures 64 and 74 and hand knob screws 76 and wing nuts 78. For example, the apertures 74 of the upper front and rear swing arms 32 and 34 may align with the apertures 64 of the lower front and rear swing arms 28 and 30, the front aligning with the front and the rear with the rear. One or more hand knob screws 76 and wing nuts 78 may be used to secure the front upper swing arm 32 to the front lower swing arm 28 and the rear upper swing arm 34 to the rear lower swing arm 30.

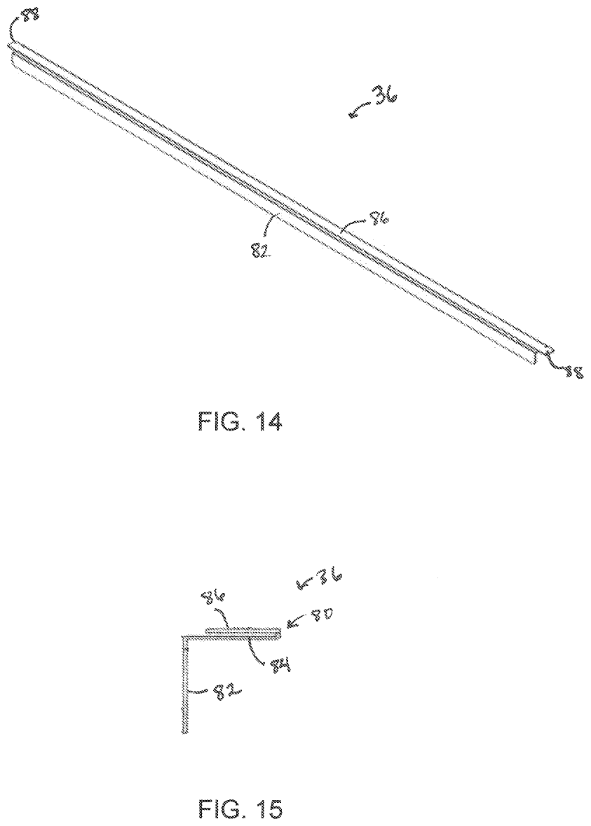

With reference now specifically to FIGS. 14 and 15, the support bar 36 is illustrated. The support bar 36 may secure to the length of a solar panel frame and may provide support to the solar panel 12 along its length when the solar panel 12 is attached to a pivoting bracket 16. The support bar 36 may have a clip 80 and a side wall 82. The clip 80 may have a base face 84 and a top face 86. In some embodiments, the top face 86 may be folded over the base face 84 leaving a small space between the top face 86 and the base face 84. The base face 84 and the side wall 82 may form an L-bar being connected together at their lengths forming a ninety-degree angle. The top face 86 may be longer than the base face 84 such that a portion of the top face 86 extends outward from either end of the base face 84 forming end wings 88.

The support bar 36 may be clipped to the length of a solar panel 12 by sliding a length of the frame of a solar panel 18 between the bottom face 84 and the top face 86 of the clip 80. Once the frame is secured within the clip 80, the end wings 88 of the support bar 36 may rest in opposite corners of the solar panel frame. The support bar 36 may further be secured to the frame of a solar panel 12 through the use of bolts, nuts, and washers.

With reference now to FIGS. 16-17, the functioning of the one or more struts 38 is illustrated. As mentioned above, the one or more pivoting brackets 16 may each have a solar panel 12 mounted thereon. The pivoting brackets 16 may secure the solar panel 12 to the one or more ladder racks 14 but still allow the solar panels 12 to pivot about one or more axis. When pivoted from a flat position on the ladder racks 14 to be angled, the strut 38 may function to secure the solar panel 12 in the chosen angle. This may be accomplished by connecting the strut 38 at one end to one of the plurality of apertures 64 of the rear lower swing arm 30 and the other end of the strut 38 to one of the plurality of apertures 74 of the rear upper swing arm 34. The angle of the solar panel 12 may be adjusted depending on which ones of the plurality of apertures 64 and 74 are used. In like manner, a strut 38 may be connected to the front upper and lower swing arms 28 and 32.

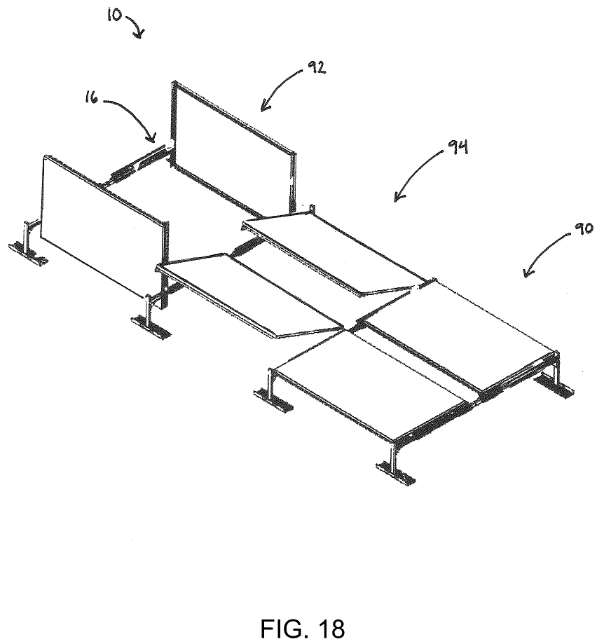

With reference now to FIG. 18, an environmental view is illustrated showing the various angles at which the solar panels 12 may be positioned. FIG. 18 illustrates sets of solar panels 12 in different positions from each other to illustrate a few of the various position options, as will be described below. However, the sets of solar panels may all be set to be in the same positions. First, the solar panels 12 may have a zero-degree positioning 90 in relation to the ladder racks 14. This position 90 is ideal for when the vehicle is traveling or moving. Second, the solar panels 12 may be positioned at a ninety-degree angle 92. This position 92 is ideal for when access to the roof of a vehicle is needed as it allows the user to move the solar panels 12 out of the way of the roof without having to take the solar panels 12 off of the solar mount 10. Finally, the solar panels 12 may be positioned at an angle between zero and ninety-degrees 94 to allow the solar panels 12 to point toward the sun to produce the maximum amount of solar energy possible.

When placed at an angle 94 to point towards the sun, the solar panel 12 angled toward an edge of the solar mount 10 may pivot at an axis between the lengths of the solar panel 12 while the solar panel 12 angled toward the middle of the solar mount 10 may pivot at an axis along a length of the solar panel 12. In this manner, the solar panel 12 angled toward the edge of the solar mount 10 may sit lower on the solar mount 10 than the solar panel 12 angled toward the middle of the solar mount 10. This will allow the solar panel 12 angled toward the middle of the solar mount 10 to be out of the shadow of the solar panel 12 angled toward the edge of the solar mount 10 and thus to receive the maximum amount of solar energy from the sun as possible.

FIG. 18 illustrates the solar panels 12 in position 94 angled toward the right edge of the solar mount 10. However, the solar panels 12 may also be angled toward the left edge in similar manner to the positioning 94 described above.

Changing of the positions of the solar panels may be accomplished manually as described above. In other embodiments, however, the positioning of the solar panels may be accomplished through one or more motors, gears, and/or belts set up to actuate the changing of angles of each of the solar panels 12. The motors may be powered through a provided battery or may be electronically connected to the battery of the vehicle. The motors may include a wireless networking technology that may connect to a user device such as a computer, tablet, phone, etc. having an application installed through which the motors may be controlled.

Although specific embodiments, methods and systems of the solar mount 10 have been described in detail above for purposes of illustration, various modifications may be made without departing from the scope and spirit of the invention. Accordingly, the invention is not to be limited except as by the appended claims.

What is claimed is:

1. A solar mount comprising:
two or more ladder racks wherein each ladder rack is comprised of two feet, two vertical bars, and one crossbar, wherein the feet of the ladder racks are configured to be secured to a surface;
one or more cables configured to connect to and provide support to the two or more ladder racks;
one or more pivoting brackets comprised of one or more saddle mounts, a front lower swing arm, a rear lower swing arm, a front upper swing arm, a rear upper swing arm, a support bar, and one or more struts, wherein the front lower swing arm may be secured to a ladder rack by one or more saddle mounts, wherein the rear lower swing arm may be secured to an adjacent ladder rack by one or more saddle mounts, wherein the front upper swing arm may be secured to the front lower swing arm at a first front locking pivot point and a second front locking pivot point and the rear upper swing arm may be secured to the rear lower swing arm at a first rear locking pivot point and at a second rear locking pivot point, wherein a solar panel may be secured to the front and rear upper swing arms, wherein the support bar may be positioned to extend from the front upper swing arm to the rear upper swing arm and configured to provide support to the solar panel, and
wherein the solar panel may pivot at the second pivot points and be secured into a desired position by the one or more struts such that a portion of the solar panel forms a negative angle in relation to the crossbars of the ladder racks and a portion of the solar panel forms a positive angle in relation to the crossbars of the ladder racks, or the solar panel may pivot at the first pivot points and be secured into a desired position by the one or more struts such that the solar panel forms a positive angle with the crossbars of the ladder racks.

2. The solar mount of claim 1 wherein the solar mount is configured to be secured to the roof of a vehicle.

3. The solar mount of claim 1 further comprising one or more tensioning nuts connected in line with the one or more cables and configured to allow for the tensioning or loosening of the one or more cables.

4. The solar mount of claim 1 wherein two pivoting brackets may each secure a solar panel on the same two ladder racks such that an alley way is formed between the two solar panels.
